(19) United States
(12) Patent Application Publication
(10) Pub. No.: US 2026/0351612 A1
(43) Pub. Date: Nov. 5, 2026

(54) Primary Cell with Electrode Element and Method for Manufacturing

(71) Applicant: LITRONIK Batterietechnologie GmbH, Pirna (DE)

(72) Inventors: Marcel Elsner, Dresden (DE); Thomas Hucke, Dresden (DE); Benjamin Buschbeck, Dresden (DE); Phillip Reichel, Dresden (DE)

(73) Assignee: LITRONIK Batterietechnologie GmbH, Pirna (DE)

(21) Appl. No.: 19/158,341

(22) PCT Filed: Feb. 20, 2024
(86) PCT No.: PCT/EP2024/054238

§ 371 Date: Aug. 20, 2025

(30) Foreign Application Priority Data
Feb. 22, 2023 (EP) 23157926.9

(51) Int. Cl. H01M 4/62; H01M 4/50

(52) U.S. Cl. CPC H01M 4/625; H01M 4/50; H01M 4/621

(57) ABSTRACT

A primary electrochemical cell including a first electrode element having an electrode body including an electrode active material and a first conductive carbon additive, wherein said first conductive carbon additive is a carbon black characterized by a Brunauer-Emmet-Teller specific surface area of at least 100 m2*g-1 and a mean grain size below 1 μm. A method for manufacturing a first electrode element for a primary electrochemical cell is further disclosed.

### CROSS-REFERENCE TO RELATED APPLICATIONS

This application is the United States National Phase under 35 U.S.C. § 371 of PCT International Patent Application No. PCT/EP2024/054238, filed on Feb. 20, 2024, which claims the benefit of European Patent Application No. 23157926.9, filed on Feb. 22, 2023, the disclosures of which are hereby incorporated by reference herein in their entireties.

### TECHNICAL FIELD

The present invention relates to a primary cell with an electrode element, a method for manufacturing, and use of such electrode element.

### SUMMARY

Due to the significantly growing distribution of consumer electronics and the considerable promoting of electromobility, there is steadily increase demand for electrode elements that are characterized by desirable properties such as an enhanced capacity, a decreased resistance and an optimal voltage curve. At the same time, there is a constant demand for improved manufacturing methods that are optimized in terms of efficiency and costs.

Thus, it is an objective of the present invention to provide improved electrodes and methods of manufacturing.

This objective is attained by a primary electrochemical cell having the features of claim 1, and a process having the features of claim 10.

According to claim 1, a primary electrochemical cell comprising a first electrode element is provided. The electrode element according to the present invention comprises an electrode body comprising an electrode active material and a first conductive carbon additive. According to the invention it is particularly envisioned that the first conductive carbon additive is a nanostructured carbon black characterized by a Brunauer-Emmet-Teller (BET) specific surface area of at least 100 m²*g⁻¹ and a mean grain size below 1 μm.

The use of a nanostructured carbon or carbon black provides several advantages. The nanostructured carbon or carbon black, when homogeneously distributed in the electrode body, forms a percolating electronic network, along which electrode active material of the electrode body is supplied with an electrolyte, wherein the electrolyte is adsorbed in micropores and the high specific surface of the nanostructured carbon or carbon black. As a result, the fraction of the first conductive carbon additive may be reduced and fraction of the electrode active material may be increased, which results in an increased energy density and/or power density. As a further result, the pulse voltage value is increased from mid-of-life (MOL) to end-of-life (EOL).

The term “Brunauer-Emmet-Teller (BET) specific surface area” is used in the meaning known to the skilled person. It particularly relates to the surface area of solid or porous materials. It may be determined by the measurement of the amount of gas required for a monolayer loading and the resulting determination of the accessible external and internal surface of porous solids. To remove all gas and water molecules, the samples are typically baked in a vacuum at T=100 °C for one hour. The measurement is then commonly carried out after the sample mass was determined at a constant temperature of −196 °C (liquid nitrogen in a Dewar vessel) with nitrogen as the adsorption gas.

The term “mean grain size” is used in the meaning known to the skilled person. It particularly refers to the median of a grain size distribution of particles, e.g., of particles of the first conductive carbon additive. This value is also known as D50. Suitable methods for determining the particle size or the grain size distribution include laser diffraction analysis, or small angle scattering (e.g., using X-rays or neutron radiation).

In one embodiment of the primary electrochemical cell according to the invention, the electrode body of the first electrode element comprises the first conductive carbon additive (11) in a mass fraction in the range of 1% (w/w) to 5% (w/w) with regard to the mass of the electrode element. In one embodiment, the electrode body comprises the first conductive carbon additive (11) in a mass fraction in the range of 1% (w/w) to 2.5% (w/w)

In one embodiment of the primary electrochemical cell according to the invention, the electrode active material of the first electrode element is selected from is manganese dioxide or carbon monofluoride. In one embodiment, the electrode active material is present in the electrode body in a mass fraction in the range of 87% (w/w) to 97% (w/w) with regard to the mass of the electrode element. In one embodiment, the electrode active material essentially consists of or comprises manganese dioxide and is present in the electrode body in a mass fraction in the range 90% (w/w) to 93.5% (w/w) with regard to the mass of the electrode element. In one embodiment, the electrode active material essentially consists of or comprises carbon monofluoride and is present in the electrode body in a mass fraction in the range 87% (w/w) to 97% (w/w) with regard to the mass of the electrode element. In one embodiment, electrode element comprises the first carbon additive in a mass fraction in the range of 1% (w/w) to 2.5% (w/w) with regard to the total mass of the electrode element, particularly about 2.5% (w/w).

In one embodiment of the primary electrochemical cell according to the invention, the manganese dioxide is mixture of at least a first and a second powdered fraction, wherein the first powdered fraction is characterized by a smaller mean grain size than the second powdered fraction. In one embodiment, the first powdered fraction is characterized by a mean grain size in the range of 20 μm to 40 μm. In one embodiment, the second powdered fraction has a mean grain size in a range of from 40 μm to 80 μm. In one embodiment, the mass fraction of the first powdered fraction with regard to the total mass of the manganese dioxide is in the range of 35% to 50%, particularly 42%. In one embodiment, the mass fraction of the second powdered fraction with regard to the total mass of the manganese dioxide is in the range of 50% to 65%, particularly 58%. In one embodiment, the electrode body comprises the manganese dioxide in a mass fraction in the range of 90% to 93.5% with regard to the total mass of the electrode body.

In a further embodiment of the primary electrochemical cell according to the invention, the electrode body of the first electrode element further comprises a second conductive carbon additive. In one embodiment, the second conductive carbon additive is selected from graphite, e.g. GNP 6 (RMC Remacon GmbH), or KS6 (Imerys Graphite & Carbon). In one embodiment, the electrode body comprises the second conductive carbon additive in a mass fraction in the range of 0.5% to 5% with regard to the total mass of the electrode body. In one embodiment, the electrode body comprises the second conductive carbon additive in a mass fraction in the range of 0.5% to 1.5% with regard to the total mass of the electrode body.

In a further embodiment of the primary electrochemical cell according to the invention, the electrode body further comprises a binder. In one embodiment, the binder is selected from polytetrafluoroethylene (PTFE), carboxymethylcellulose (CMC), particularly the sodium salt of carboxymethylcellulose (Na-CMC), styrene butadiene rubber (SBR), or mixture of carboxymethylcellulose and styrene butadiene rubber (CMC: SBR). In one embodiment, the electrode element comprises manganese dioxide as electrode active material and the binder, particularly PTFE, in a mass fraction in the range of 1% to 4% with regard of the total mass of the electrode body, particularly about 2.5%. In another embodiment, the electrode element comprises carbon monofluoride as electrode active material and the binder, particularly carboxymethylcellulose (CMC), styrene butadiene rubber (SBR), or mixture of carboxymethylcellulose and styrene butadiene rubber (CMC: SBR), in mass fraction of 2% (w/w) to 6% (w/w) with regard to the total mass of the electrode body, particularly about 4.5% (w/w).

In an embodiment, the primary electrochemical cell according to the invention comprises a second electrode element, wherein the second electrode element comprises an alkali metal as electrode active material. In one embodiment, the alkali metal is selected from lithium, sodium and potassium, wherein lithium is preferred.

In a further embodiment, the primary electrochemical cell according to the invention further comprises an electrolyte, preferably a non-aqueous electrolyte, wherein particularly the first electrode comprises as an electrode active material an alkali metal, particularly selected from lithium, sodium or potassium. Suitable electrolytes include, without being restricted to, non-aqueous, preferable aprotic, solvents, such as an ester, an ether and a dialkyl carbonate, particularly tetrahydrofuran, methyl acetate, diglyme (bis(2-methoxyethyl)ether), triglyme (tris(2-methoxyethyl)ether), tetraglyme (tetra(2-methoxyethyl)ether), 1,2-dimethoxyethane, 1,2-diethoxyethane, 1-ethoxy-2-methoxyethane, dimethyl carbonate, diethyl carbonate, dipropyl carbonate, ethyl methyl carbonate, methyl propyl carbonate, ethyl propyl carbonate or a mixture thereof, or a cyclic carbonate, a cyclic ester, a cyclic amide, particularly propylene carbonate, ethylene carbonate, butylene carbonate, γ-butyrolactone, N-methyl pyrrolidinone or a mixture thereof. Suitable electrolytes also comprise polar non-aqueous solvents such as acetonitrile, dimethyl sulfoxide, dimethyl formamide, dimethyl acetamide or a mixture thereof.

In a further embodiment, the electrolyte comprises at least one conductive salt. The conductive salt is preferably an inorganic alkali metal salt, whereby the alkali metal cation is the same as the active anode material. Suitable anions are PF₆_{^{−}}, BF₄_{^{−}}, AsF₆_{^{−}}, SbF₆_{^{−}}, ClO₄_{^{−}}, O₂_{^{−}}, AlCl₄_{^{−}}, GaCl₄_{^{−}}, SCN⁻, SO₃(C₆F₅)⁻, C(SO₂CF₃)₃_{^{−}}, N(SO₂CF₃)₂_{^{−}} and SO₃CF₃ among others. In a preferred embodiment, the concentration of the conductive salt is 1 mol/l.

In a further embodiment, the primary electrochemical cell according to the invention further comprises at least one separator arranged between the first electrode element and the second electrode element. Suitable separator comprises non-metallic materials, particularly polymers such as polyethylene or polypropylene, polyamides such as Nylon or fluoropolymers such as an ethylene tetrafluoroethylene copolymer (ETFE) or polytetrafluoroethylene (PTFE). Preferably, the separator is designed in form of a membrane or pocket and may be wetted with an electrolyte before arranging the separator between the first and second electrode particularly with one of the electrolytes stated in the above embodiments.

According to claim 10, a process for manufacturing an electrode element is provided. The process comprises the steps of:
providing a first electrode active material, a first conductive carbon additive and optionally a second conductive material,
mixing the first electrode active material, the first conductive carbon additive and optionally a second conductive carbon additive yielding a (homogeneous) dry mixture, particularly a homogenous dry mixture,
providing a binder suspension comprising a solvent and at least a first binder, wherein particularly the solvent is an aqueous solvent or water,
mixing the binder suspension to the dry mixture to yield a wet granulate,
drying the wet granulate yielding a dried granulate, and
forming the dried granulate into an electrode body.

Upon adding the binder suspension to the dry mixture, the particles of the dry mixture become wetted and spontaneously form agglomerations, i.e. grains. Therein, the mean grain size of the wet granulate may advantageously be adjusted by applying predefined ratios of the dry mixture and the binder suspension. In this matter, it may be advantageous to first add a first predefined amount of the aqueous solvent to the dry mixture, afterwards a predefined amount of the binder suspension, and afterwards optionally a second predefined amount of the aqueous solvent.

In one embodiment of the process according to the invention, the first conductive carbon additive (12) is a carbon (black) characterized by a Brunauer-Emmet-Teller (BET) specific surface area of at least 100 m²*g⁻¹ and a mean diameter below 1 μm.

Accordingly, in one embodiment of the process according to the invention, the step of mixing the binder suspension and the dry mixture to yield the wet granulate includes the steps of: adding a first predefined amount of the solvent to said dry mixture, then adding the binder suspension, and/or adding a second predefined amount of the solvent after adding the binder suspension. In a preferred embodiment, a first predefined amount of the solvent is added to the dry mixture, then the binder suspension is added, and then a predefined second amount is added to yield the wet granulate.

Furthermore, the dry mixture may advantageously be mixed under agitation, e.g. stirring or shaking, before addition of the aqueous solvent and/or binder suspension, particularly in order to yield a homogenous dry mixture, particularly in a mixing device. In addition, the aqueous solvent and/or the binder suspension may be advantageously added under agitation of the dry mixture, e.g. under stirring or shaking the dry mixture, preferably in the mixing device used for providing the dry mixture.

Accordingly, in one embodiment of the process according to the invention, mixing the first electrode active material, the first conductive carbon additive and optionally a second conductive carbon additive, and/or mixing said binder suspension and said dry mixture to yield a wet granulate is conducted under agitation by means of the mixing device.

In a preferred embodiment, the mixing device comprises a rotatable mixing vessel and a rotatable mixing tool. In one embodiment, the rotation directions of the mixing vessel and the mixing tool are opposite to one another, wherein the mixing vessel and the mixing tool may rotate essentially around the same rotation axis or around different rotation axis's. In one embodiment, the electrode active material, the first conductive carbon additive, and optionally the second conductive carbon additive, are mixed in the mixing device at a rpm (revolutions per minute) ratio between the vessel and tool in the range of 1:55 to 1:65, particularly about 1:60. In one embodiment, the solvent and/or the binder suspension are added the dry mixture to yield the wet granulate at a rpm (revolutions per minute) ratio between the vessel and tool in the range of 1:100 to 1:50, particularly about 1:78. In one embodiment, the mixing tool is rotated with a rpm in the range of 2000 min⁻¹ to 5000 min⁻¹ during mixing the electrode active material, the first conductive carbon additive, and optionally the second conductive carbon additive to yield the dry mixture and/or during adding the solvent and/or the binder suspension to the dry mixture to yield the wet granulate, particularly at a rpm of about 3750 min⁻¹ during mixing the electrode active material, the first conductive carbon additive, and optionally the second conductive carbon additive to yield the dry mixture, and/or at a rpm of about 4500 min⁻¹ during addition of the solvent and/or the binder suspension to the dry mixture to yield the wet granulate. In one embodiment, the mixing vessel is rotated with a rpm in range of 50 min⁻¹ to 65 min⁻¹, particularly about 58 min⁻¹. In one embodiment, the electrode active material, the first conductive carbon additive, and optionally the second conductive carbon additive are mixed to yield the dry mixture over a time period in the range of 30 s to 120 s, preferably for about 80 s, particularly in the above described mixing device, particularly with the above mentioned rpms for the mixing vessel and or the mixing tool. In one embodiment, the wet granulate is agitated after adding the solvent and/or the binder suspension over a time period in the range of 100 s to 300 s, particularly about 200 s, particularly in the above described mixing device, particularly with the above mentioned rpms for the mixing vessel and or the mixing tool.

However, it may be necessary to adjust the mean grain size of the dried granulate. This can be achieved, for example, by sieving the dried granulate to the desired mean grain size.

Preferably, the steps of mixing the electrode active material, the first conductive carbon additive, and optionally the second conductive carbon additive to yield the dry mixture and/or during adding the solvent and/or the binder suspension to the dry mixture to yield the wet granulate are conducted at room temperature.

One advantage of the process according to the invention is the provision of an electrode material in a granular form, which is more easily handleable compared to non-granulated powders, particularly in terms of dust development and flowability. This particularly of importance for the manufacturing of the electrode element according to the invention, since the first conductive carbon additive can be only poorly handled due to its very small particle size.

In one embodiment of the process according to the invention, the first electrode active material comprises or essentially consists of carbon monofluoride.

In one embodiment, the manganese dioxide is provided as a powder having a mean grain size in the range of 10 μm to 100 μm. In one embodiment, the manganese dioxide is mixture of at least a first and a second powdered fraction, wherein the first powdered fraction is characterized by a smaller mean grain size than the second powdered fraction. In one embodiment, the first powdered fraction is characterized by a mean particles size in the range of 20 μm to 40 μm. In one embodiment, the second powdered fraction has a mean grain size in a range of from 40 μm to 80 μm. In one embodiment, the mass fraction of the first powdered fraction with regard to the total mass of manganese dioxide is in the range of 35% to 50%, particularly about 42%. In one embodiment, the mass fraction of the second powdered fraction with regard to the total mass of manganese dioxide is in the range of 50% to 65%, particularly about 58%. In one embodiment, the dry mixture comprises manganese dioxide in a mass fraction in the range of 90% to 93.5% with regard to the total mass of the electrode body.

In a further embodiment of the process according to the invention, the second conductive carbon additive is selected from graphite, e.g., GNP 6 (RMC Remacon GmbH), or KS6 (Imerys Graphite & Carbon). In one embodiment, the dry mixture comprises the second conductive carbon additive in a mass fraction in the range of 0.5% to 5% with regard to the total mass of the dry mixture, particularly in the range of 0.5% to 1.5%.

In a further embodiment of the process according to the invention, the binder suspension comprises a binder selected from polytetrafluoroethylene (PTFE), carboxymethylcellulose, particularly the sodium salt of carboxymethylcellulose (Na-CMC), styrene butadiene rubber (SBR), or a mixture of carboxymethylcellulose and styrene butadiene rubber (SBR: CMC) particularly in case of the electrode active material comprises or essentially consists of manganese dioxide, or the binder is selected from polyvinylidene difluoride (PVDF), carboxymethylcellulose, styrene butadiene rubber (SBR) or a mixture of carboxymethylcellulose and styrene butadiene rubber (CMC: SBR), particularly in case of the electrode active material comprises or essentially consists of carbon monofluoride. In one embodiment, the binder suspension comprises polytetrafluoroethylene (PTFE) as binder in a mass concentration in the range of 50% to 70%, particularly about 60%, particularly in case of the electrode active material comprises or essentially consists of manganese dioxide. In one embodiment, the aqueous solvent is water. In another embodiment, the binder suspension comprises carboxymethylcellulose, styrene butadiene rubber (SBR), or a mixture of carboxymethylcellulose and styrene butadiene rubber (SBR: CMC) as binder in a mass concentration in the range of 2% to 6%, particularly about 4.5%

In a further embodiment of the process according to the invention, the dried granulate is characterized by a mean grain size in the range of 200 μm to 600 μm, particularly in the range of 300 μm to 350 μm, more particular about 318 μm.

According to a further aspect of the invention, a medical device, particularly an implantable medical device, is provided, wherein the medical device comprises an electrode element according to claim 1 or one embodiment thereof stated above, an electrode element manufactured by the process according to claim 9 or an embodiment thereof, or an electrochemical cell according to claim 15 or one embodiment thereof.

### BRIEF DESCRIPTION OF THE DRAWINGS

Further details of aspects of the present invention will be explained with respect to embodiments and accompanying Figures. In the Figures:

FIG. 1 shows a schematic drawing of an electrode element according to the prior art,

FIG. 2 shows a schematic drawing) of an electrode element according to the invention.

FIG. 3 shows a schematic drawing of the granulation process according to the invention

FIGS. 4 to 7 shows a voltage curves of electrode elements according to the prior art in comparison with voltage curves of electrode elements according the invention.

### DETAILED DESCRIPTION

FIG. 1A schematically illustrate the structure of a cathode element according to the state of the art comprising an electrode body in electrically conductive communication with a current collector 15. Commonly, the electrode body is a mixture of an electrode active material 11, e.g., carbon monofluoride or manganese oxide, and conductive carbon additives, such a carbon black 16 and graphite 13 to enhance the electrical conductivity of the electrode body. However, particularly the used carbon black is characterized by a rather low BET, thus more graphite 13 has to be added to achieve the desired conductivity.

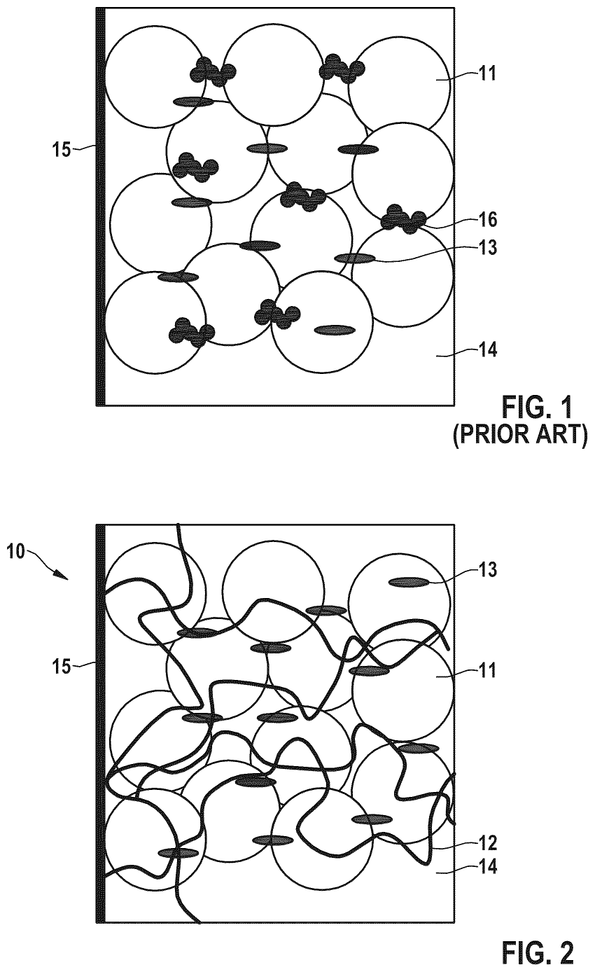

In contrast to the above described state of the art cathode element, the electrode element 10 according to the invention utilizes an improved design and composition, which is shown in FIG. 2 and described in the following. According to the invention, it is particularly envisioned to use a conductive nanostructured carbon additive 12 in the electrode body 16, which is particularly characterized by a mean grain size below 1 μm and a specific surface of at least 100 m²*g⁻¹). Advantageously, the conductive nanostructured carbon additive 12 according to the invention combines high electrical conductivity with high electrolyte absorption and forms a percolated electron network 12 within the electrode body (FIG. 2). Furthermore, the conductive nanostructured carbon additive 12 may be effectively used in reduced concentrations when compared to conductive additive according to state-of-the-art. As a result, the amount of the electrode active material 11, e.g. manganese dioxide or carbon monofluoride, may be increased and consequentially the energy/power density.

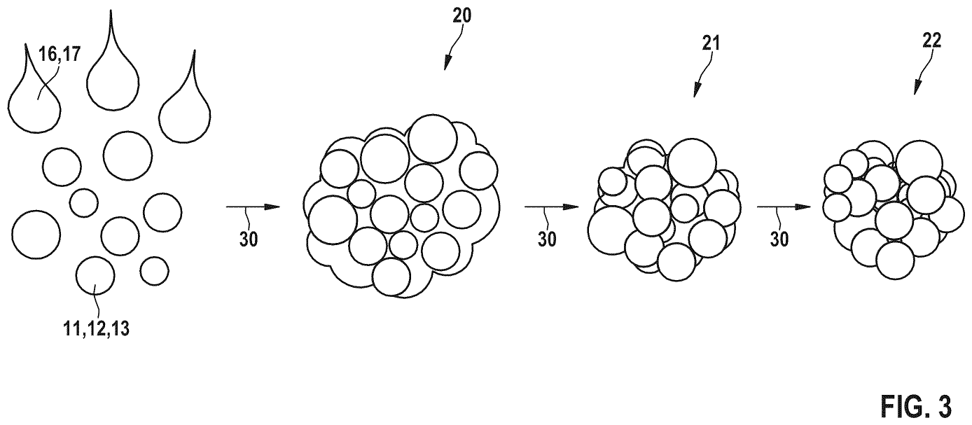

The electrode body advantageously may be formed by a granulation process exemplary shown in FIG. 3 and described in the following. In a first step, a suspension comprising a solvent 16, preferably water, and an organic binder 17, such as PTFE, CMC, SBR or SBR: CMC, is added to a powdered electrode composition comprising an electrode active material 11, such as manganese dioxide or carbon monofluoride, and conductive carbon additives, particularly the nanostructured carbon additive 12 according to the invention and optionally graphite 13. Upon addition of the suspension 16, 17, the powdered composition 11, 12, 13 gets wetted 20 by the suspension 16, 17, whereupon the particles of the powdered composition 11, 12, 13 spontaneously agglomerate 30 to larger particles 21. The larger particles 30 are now dried to yield a dry granulate of the electrode composition.

### Comparative Example 1: Electrode Element with Manganese Oxide According to the State of the Art

For manufacturing of a first comparative electrode element according to the state of art, 200 g of a powdered composition comprising manganese dioxide 11 (180 g), carbon black P50uv 12 (5 g) and graphite GNP6 13 (10 g) was mixed for 80 s at 3750 rpm, particularly using mixing device with a rotating vessel and a mixing element rotating in the opposition direction, with the mixing tool rotating with about 3750 rpm. Then, 25 ml water 15, 8.37 g of the binder suspension 16, 17 (60% PTFE in water), and 5 ml water 15 were consecutively added to the powdered composition 11, 12, 13 whiles being mixed at 4500 rpm, particularly in the above described mixing device. The wetted composition 20 was let to granulate for 200 s under agitation at 4500 rpm to form a wet granulate 21. The wet granulate 21 was dried for 12 at 130 °C and 200 mbar. Subsequently, particles larger than 500 μm were separated by sieving.

### Example 1: Electrode Element with Manganese Oxide According to the Invention

For manufacturing of a first electrode element according to the invention, 200g of a powdered composition comprising manganese dioxide 11 (187 g), a nano-structured carbon black ENSACO350G (5 g), and graphite GNP6 12 (3 g) was mixed for 80 s at 3750 rpm, particularly using mixing device with a rotating vessel and a mixing element rotating in the opposition direction, with the mixing tool rotating with about 3750 rpm. Then, 25 ml water 15, 8.37 g of the binder suspension 14, 15 (60% PTFE in water), and 5 ml water 15 were consecutively added to the powdered composition 11, 12, 13 whiles being mixed at 4500 rpm, particularly in the above described mixing device. The wetted composition 20 was let to granulate for 200 s under agitation at 4500 rpm to form a wet granulate 21. The wet granulate 21 was dried for 12 at 130 °C and 200 mbar. Subsequently, particles larger than 500 μm were separated by sieving. The final composition of the granulate is then manganese dioxide 11 (187 g), ENSACO350G (5 g), and graphite GNP6 12 (3 g) and PTFE (5 g). This first example utilizes a nanostructured carbon black (ENSACO350G) characterized by a high specific BET and a small mean grain as a first conductive carbon additive. Advantageously, the second carbon additive (graphite) may be added in a smaller amount, whereby the amount of the active electrode material (manganese oxide), and thus the energy density of the electrochemical cell can be increased.

### Comparative Example 2: Electrode Element with Carbon Monofluoride According to the State of the Art

For manufacturing of a second comparative electrode element according to the state of art, 100 g of a powdered composition comprising carbon monofluoride 11 (83 g), graphite BNB90 13 (10 g) and PVDF (7 g) as a binder was mixed yielding a dry electrode material mixture.

### Example 2: Electrode Element with Carbon Monofluoride According to the Invention

For manufacturing of a second electrode element according to the invention, 100 g of a powdered composition comprising carbon 1.5 monofluoride 11 (93.5 g), carbon black LITX-200 12 (2.5 g) and graphite GNP6 13 (1.5 g) was mixed for 80 s at 3750 rpm, particularly using mixing device with a rotating vessel and a mixing element rotating in the opposition direction, with the mixing tool rotating with about 3750 rpm. Then, 25 ml ethanol, and 50 ml of the binder suspension 16, 17 (6% SBR: CMC in water), were consecutively added to the powdered composition 11, 12, 13 whiles being mixed at 4500 rpm, particularly in the above described mixing device. The wetted composition 20 was let to granulate for 200 s under agitation at 4500 rpm to form a wet granulate 21. The wet granulate 21 was dried for 12 at 130 °C and 200 mbar. Subsequently, particles larger than 800 μm were separated by sieving. The final composition of the granulate of the second electrode element according to the invention is then: carbon monofluoride 11 (93.5 g), carbon black LITX-200 12 (2.5 g) graphite GNP6 13 (1.5 g), and CMC:SBR (2.5 g). Also, the second example utilizes a nanostructured carbon black (LITX-200) characterized by a high specific BET and a small mean grain as a first conductive carbon additive. Also in this case, the second carbon additive (graphite) may be added in a smaller amount, whereby the amount of the active electrode material (carbon monofluoride), and thus the energy density of the electrochemical cell can be increased.

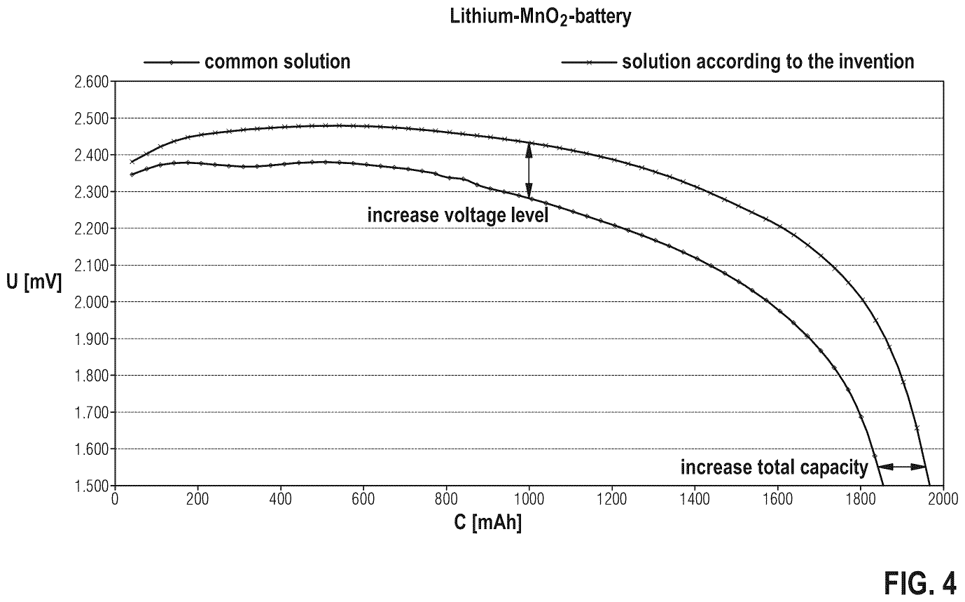

FIGS. 4 to 7 illustrate particularly the advantageous effect of the conductive nanostructured carbon additive 12. Each of the figures show a voltage curve of an electrode element 10 according to the prior art in comparison with an electrode element according to the invention, wherein both electrode elements (formed as cathode) are used in combination with lithium as electrode active material of the counter electrode (anode).

In detail, FIG. 4 shows the discharge curves of electrode elements (prior art and according to the invention) with regard to the absolute capacity, wherein both electrode elements use manganese dioxide as electrode active material. The electrode element 10 according to the invention exhibits a higher voltage curve and an increased absolute capacity.

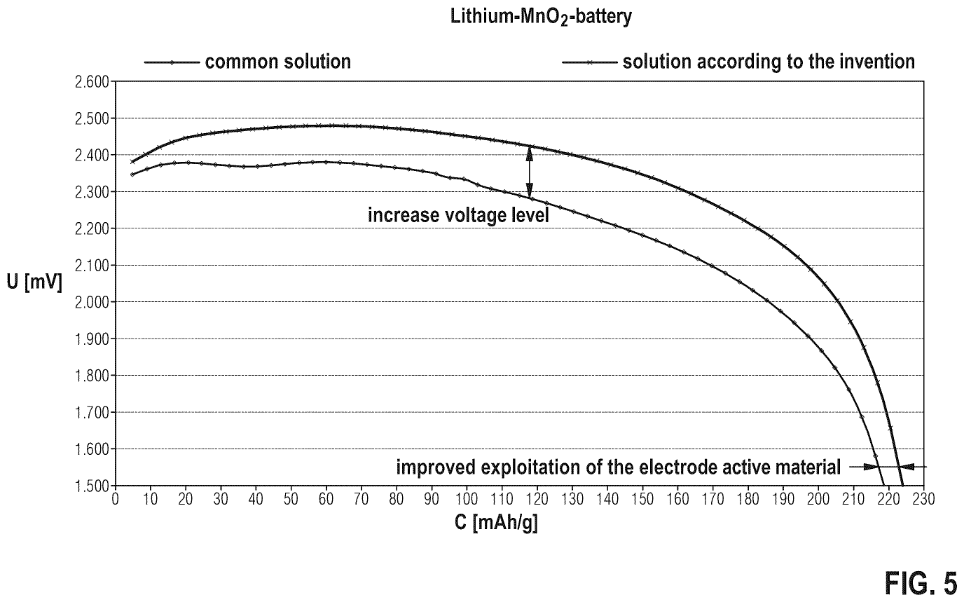

FIG. 5 show the discharge curves of electrode elements (prior art and according to the invention) with regard to the specific capacity, wherein both electrode elements use manganese dioxide as electrode active material. Also here, the electrode element 10 according to the invention exhibits a higher voltage curve. In addition, the electrode element 10 according to the invention shows an improved utilization or exploitation of the electrode active material 11.

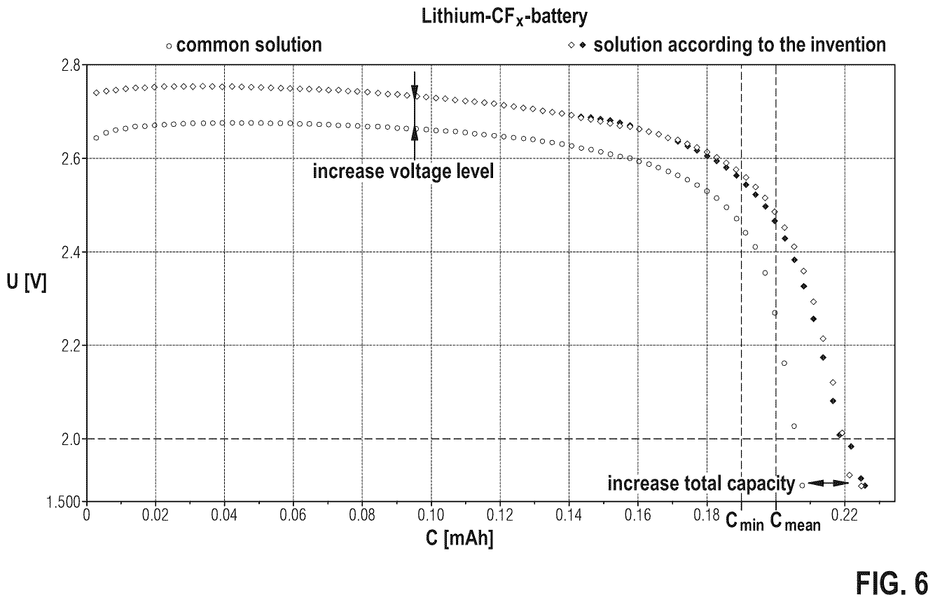

FIG. 6 shows the discharge curves of electrode elements (prior art and according to the invention) with regard to the absolute capacity, wherein both electrode elements use carbon monofluoride as electrode active material 11. Also with this electrode active material 11, the electrode element 10 according to the invention exhibits a higher voltage curve and an increased absolute capacity.

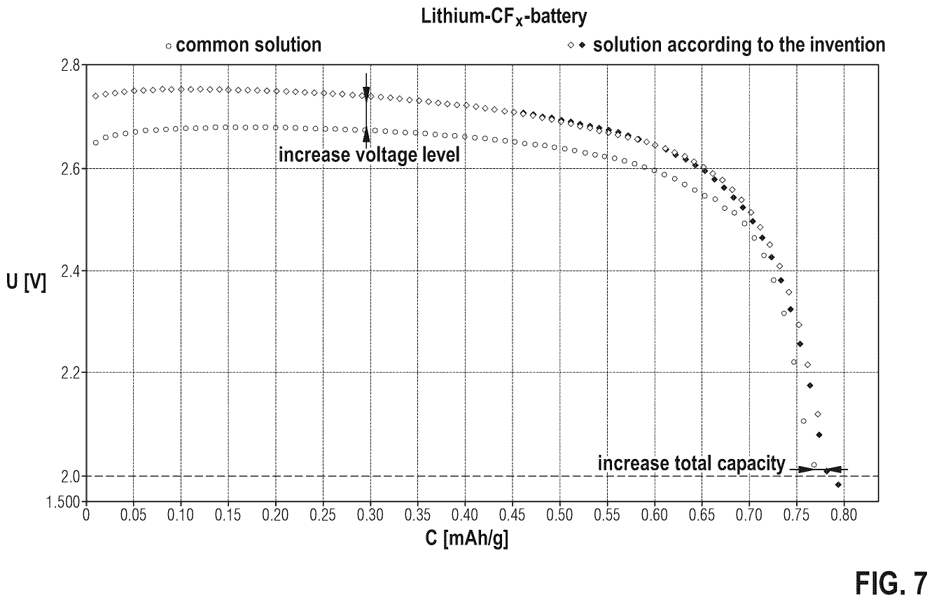

FIG. 7 shows the discharge curves of electrode elements (prior art and according to the invention) with regard to the specific capacity, wherein both electrode elements use carbon monofluoride as electrode active material. Also here, the electrode element 10 according to the invention exhibits a higher voltage curve. In addition, the electrode element 10 according to the invention shows an improved utilization or exploitation of the electrode active material 11.

1. Primary electrochemical cell comprising
a first electrode element with an electrode body comprising an electrode active material and a first conductive carbon additive,
wherein said first conductive carbon additive is a carbon black characterized by a Brunauer-Emmet-Teller specific surface area of at least 100 m²*g⁻¹ and a mean grain size below 1 μm.

2. Primary electrochemical cell according to claim 1, wherein said electrode body comprises said first conductive carbon additive in a mass fraction in the range of 1% (w/w) to 5% (w/w) with regard to the total mass of the electrode body, particularly in the range of 1% (w/w) to 2.5% (w/w).

3. Primary electrochemical cell according to claim 1, wherein said electrode active material is manganese dioxide or carbon monofluoride, particularly in a mass fraction in the range of 87% (w/w) to 97% (w/w) with regard to the total mass of the electrode body.

4. Primary electrochemical cell according to claim 3, wherein said manganese dioxide is a mixture of at least a first and a second powdered fraction, wherein said first powdered fraction is characterized by a smaller mean grain size than said second powdered fraction

5. Primary electrochemical cell according to claim 4, wherein
said first powdered fraction is characterized by a mean particles size in the range of 20 μm to 40 μm, and/or
said second powdered fraction has a mean grain size in a range of from 40 μm to 80μm.

6. Primary electrochemical cell according to claim 4, wherein
the mass fraction of said first powdered fraction is in the range of 35% to 50%, particularly about 42%, and/or
the mass fraction of said second powdered fraction is in the range of 50% to 65%, particularly about 58%.

7. Primary electrochemical cell according to claim 1, wherein said electrode body comprises a second conductive carbon additive, particularly selected from graphite, particularly in a mass fraction in the range of 0.5% (w/w) to 5% (w/w), particularly in the range of 0.5% (w/w) to 1.5% (w/w) with regard to the total mass of the electrode body.

8. Primary electrochemical cell according to claim 1, wherein said electrode body comprises an organic binder, particularly in a mass fraction in the range of 2% (w/w) to 6% (w/w) with regard to the mass of the electrode body, more particular in the range of 2.5% (w/w) to 4.5% (w/w), wherein said organic binder is particularly selected from polytetrafluoroethylene, carboxymethylcellulose sodium salt, styrene butadiene rubber, or polyvinylidene difluoride or a mixture thereof.

9. Primary electrochemical cell according to claim 1, comprising
a second electrode element,
characterized in that said second electrode element comprises an alkali metal as electrode active material, particularly lithium, sodium, or potassium.

10. Process for manufacturing an electrode element for a primary electrochemical cell, comprising the steps of:
providing a first electrode active material, a first conductive carbon additive, and optionally a second conductive material, wherein said first conductive carbon additive is a carbon (black) characterized by a Brunauer-Emmet-Teller specific surface area of at least 100 m2*g−1 and a mean diameter below 1 μm,
mixing said first electrode active material, said first conductive carbon additive and optionally a second conductive carbon additive yielding a dry mixture,
proving a binder suspension comprising at least a first binder and a solvent, particularly an aqueous solvent or water,
mixing said binder suspension and said dry mixture to yield a wet granulate,
drying said wet granulate yielding a dried granulate, and
forming said dried granulate into an electrode body.

11. Process according to claim 10, wherein the step of mixing said binder suspension and said dry mixture includes:
adding a first predefined amount of said solvent to said dry mixture, then said adding said binder suspension, and/or
adding a second predefined amount of said solvent after adding said binder suspension.

12. Process according to claim 10, wherein
said mixing said first electrode active material, said first conductive carbon additive and optionally a second conductive carbon additive, and/or
said mixing said binder suspension and said dry mixture to yield a wet granulate,
is conducted under agitation, particularly by means of a mixing device, particularly comprising a mixing vessel and a mixing tool, wherein particularly the mixing vessel and the mixing tool rotate in opposite directions.

13. Process according to claim 10, wherein said first electrode active material comprises or essentially consists of carbon monofluoride (CFx) or manganese dioxide (MnO₂).

14. Process according to claim 10, wherein said binder is selected from polytetrafluoroethylene, carboxymethylcellulose, styrene butadiene rubber, a mixture of carboxymethylcellulose and styrene butadiene rubber, or polyvinylidene difluoride, wherein particularly the binder is present in the binder suspension I in a mass concentration in the range of 30% to 70%, wherein particularly said binder is styrene butadiene rubber and present in the binder suspension in mass concentration in the range of 30% to 50%, preferably about 40%, or said binder is polytetrafluoroethylene and present in the binder suspension in a mass concentration in the range of 50% to 70%, preferably about 60%.

15. Process according to claim 10, wherein the dried granulate is characterized by a mean grain size in the range of 200 μm to 600 μm, particularly in the range of 300 μm to 350 μm, more particular about 318 μm.
